(19) United States
(12) Patent Application Publication
(10) Pub. No.: US 2013/0332986 A1
(43) Pub. Date: Dec. 12, 2013

(54) METHODS AND APPARATUS FOR DYNAMICALLY REDUCING VIRTUAL PRIVATE NETWORK TRAFFIC FROM MOBILE DEVICES

(71) Applicant: BLUEBOX, San Francisco, CA (US)

(72) Inventors: Caleb Sima, San Francisco, CA (US); Adam Ely, San Francisco, CA (US)

(21) Appl. No.: 13/912,304

(22) Filed: Jun. 7, 2013

Related U.S. Application Data
(60) Provisional application No. 61/657,725, filed on Jun. 8, 2012.

(51) Int. Cl. H04L 29/06

(52) U.S. Cl. CPC H04L 63/20
USPC 726/1

(57) ABSTRACT

A computer-implemented method for dynamically directing mobile device traffic in a computing system programmed to perform the method includes receiving with the computing system, a request for resolution of a domain name associated with a web address from a mobile device, determining in the computing system, whether the domain name is not subject to security policies, determining in the computing system, a publically-accessible IP address associated with the domain name, when the domain name is determined to not be subject to the security policies, the method comprises providing from the computing system, the publically-accessible IP address associated with the domain name to the mobile, and when the domain name is determined to be subject to the security policies, the method comprises providing from the computing system, an IP address associated with the computing system to the mobile.

### CROSS-REFERENCES TO RELATED APPLICATIONS

The present application is a continuation of provisional Application No. 61/657,725; filed on Jun. 8, 2012, the full disclosures of which is incorporated herein by reference.

### FIELD OF THE INVENTION

The present invention relates to virtual private networks. More specifically, embodiments of the present invention relate to reducing network traffic on virtual private networks.

### BACKGROUND OF THE INVENTION

A Virtual Private Network, or VPN, is a private network that extends across public networks like the Internet. It enables a host computer to send and receive data across shared or public networks as if they were an integral part of the private network with all the functionality, security and management policies of the private network. The use of a VPN allows companies, governments, agencies and others to provide a securitized version of the Internet to their users. However, the use of such networks exclusively can quickly overwhelm the servers of companies and thereby slow down the work of all members of the VPN. Further, with modern smart phones and other portable devices that can access the Internet and can be part of a VPN, these networks have now become inundated with users sending requests and information to and from networks including the Internet such that VPN's have been bogged down affecting the speed of information transferal. Administrators of VPN's often need to determine what is important and what needs to be secure within the network and what can access the Internet or other networks safely outside of the VPN.

It would be preferable to have a high speed manner of determining on the fly whether a request for information needs the security of transference through the VPN or if, due to the nature of the information or request, the user can get the information from the Internet or other non-secured network safely. Objects and advantages of the present invention will become apparent as the description proceeds.

### SUMMARY OF THE INVENTION

In accordance with the present invention, a method for dynamically directing mobile device traffic in a computing system is provided. The method is directed in pertinent part to alleviating constriction of traffic in Virtual Private Networks (VPN) by selectively allowing, for example, mobile devices to access networks outside of the VPN in certain situations.

The method includes the steps of providing a computing system having elements for at least receiving and sending requests for resolution of a domain name associated with a web address from a mobile device and storing, reviewing and/or modifying requests for resolution of a domain name and operating the computing system to receive a request for resolution of a domain name, review the received request and determine whether the domain name is not subject to security policies. The method further provides the steps of determining a publically-accessible IP address associated with the domain name and when the domain name is determined to not be subject to the security policies, providing from the computing system, a publically-accessible IP address associated with the domain name to the mobile device.

It will be understood that in the method of the present invention, that when the domain name is determined to be subject to the security policies, the method will include the step of providing, from the computing system, an IP address associated with the computing system to the mobile device in response to the request for resolution of the domain name In this way, when security is required the system provides it. The invention further provides the users with the ability to maintain in storage, within the computing system, a list of domain names that are not subject to the security policies, as well, the list in storage can be supplemented when new domains are determined not to be subject to the security policy. In this way speeding the determination when requests are received. The method, therefore, included in the step of determining whether the domain name is not subject to security policies, the inclusion of the further step of determining in the computing system whether the domain name is stored in a domain name list in storage. Some examples of domain names that could be included in such a list include, but is not limited to, Youtube.com, Vimeo.com, Spotify.com, Pandora.com, Netflix.com, Hulu.com, Fidelity.com, and Schwab.com all of which, in one step of the method can be placed in the domain name list in storage.

In embodiments of the invention the step of determining in the computing system whether the domain name is subject to security policies, or not, includes the steps of determining a traffic type associated with the domain name and determining whether the traffic type is subject to security policies. In such embodiments an additional step of providing the computing system with the traffic types that is not subject to the security policies can be included.

In a preferred embodiment, the method of the invention further comprising the steps of receiving a request from a mobile device for web data associated with the web address via the IP address, sending from the computing system, a request for web data associated with the web address to a web server associated with the publically-accessible IP address and receiving the web data associated with the web address from the web server associated with the publically-accessible IP address. Then, the method can include the further steps of determining whether the web data should be modified and when it is determined that the web data should not be modified sending from the computing system, the web data associated with the web address to the mobile device in response to the request from the mobile device. It follows also that the invention can include the steps of determining whether the web data should be modified and, when it is determined that the web data should be modified, sending the modified web data to the mobile device in response to the request from the mobile device.

In a preferred embodiment, the IP address associated with the computing system comprises a virtual private network.

A more detailed explanation of the invention is provided in the following description and claims and is illustrated in the accompanying drawings.

### BRIEF DESCRIPTION OF THE DRAWINGS

FIG. 1 is a representation of a system using the method of the present invention;

FIG. 2 is a flow chart of the functionality of the present invention;

FIG. 3 is a further flow chart of the functionality of the present invention; and

FIG. 4 is a further flow chart of the functionality of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

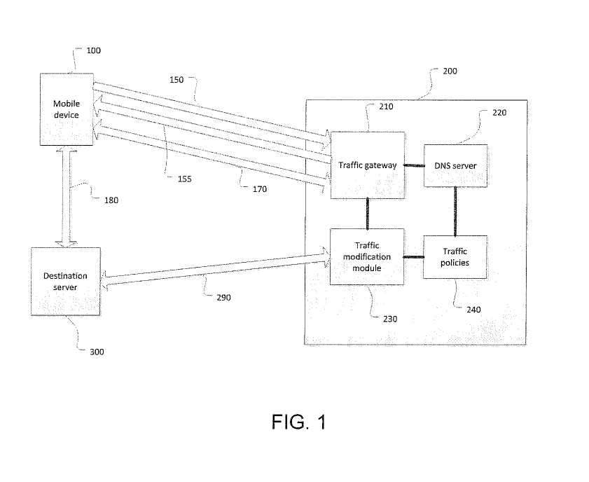

Referring to FIG. 1, mobile device 100 wishes to communicate with the destination server 300. Mobile device 100 is pre-configured to send all DNS queries to the DNS server 220 via the traffic gateway 210 of the traffic inspection system 200. The mobile device 100 is also pre-configured to route a network address range (for example 192.18.0.0/15) to the traffic gateway 210 of the traffic inspection system 200.

The mobile device 100 wishes to communicate with a server identified by the human readable DNS name “www.example.com”. The mobile device 100 performs a DNS query 150 for the hostname “ww.example.com” to the DNS server 220 via the traffic gateway 210. The DNS server 220 consults a traffic policy 240 and determines the mobile device 100 should communicate directly to the server. Thus the DNS server 220 returns a DNS response 155 to the mobile device 100 that includes the public IP address of the destination server 300. The mobile device 100 then sends and receives network traffic 180 to the destination server 300.

Also, the mobile device 100 wishes to communicate with a server identified by the human readable DNS name “www.example2.com”. The mobile device 100 performs a DNS query 150 for the host name “www.example2.com” to the DNS server 220 via the traffic gateway 210. The DNS server 220 consults a traffic policy 240 and determines the mobile device 100 should communicate to the traffic inspection system 200. Thus the DNS server 200 returns a DNS response 155 to the mobile device 100 that includes an alternate IP address that is within the pre-configured network address range the mobile device 100 assigned to the traffic gateway 210. The mobile device 100 then sends and receives network traffic 170 to the traffic gateway 210 destined to the alternate IP address. The traffic gateway 210 will receive traffic 170 form the mobile device 100 for the alternate IP, and forward the traffic to the traffic modification module 230. The traffic modification module 230 may optionally perform security inspections, modification, and analysis of the traffic data as directed by the traffic policies 240. Then, the traffic modification module 230 substitutes the alternate IP address for the public IP address of the destination server 300. This process is referred to as “DNAT”, or “destination network address translation” in the industry and to persons having ordinary skill in the art. Then the traffic modification module 230 sends and receives network traffic 290 to the destination server 300. Traffic 290 returned by the destination server 300 goes through the traffic modification module 230, where the public IP address of the destination server 300 is modified to be the alternate IP, and then the traffic 170 is sent via the traffic gateway 210 to the mobile device 100.

The method of the present invention is best reviewed using flow charts showing the various steps, it will be seen in the figures that like numbers will be used in the flow charts to show like functionality and elements of the invention.

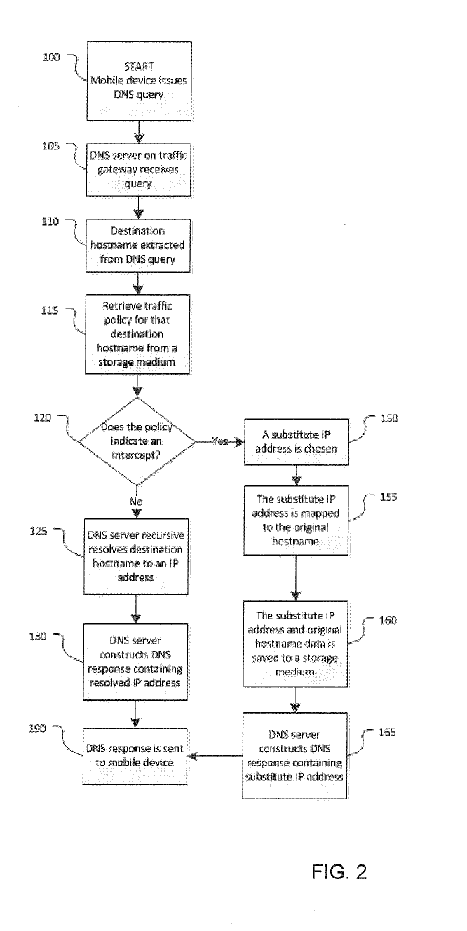

Referring now to FIG. 2, a logic flow chart of the operation of one aspect of the invention is shown. The logic flow chart of FIG. 2 shows the taking of an incoming Domain Name System (DNS) query, consultation of a traffic policy for the hostname indicated by that query and deciding whether to return the actual public IP address or a substitute IP address. More specifically, when a mobile device 100 issues a DNS query and the DNS server 220 receives 105 the query the destination hostname is extracted 110 from the DNS query and the traffic inspection system 200 (FIG. 1) retrieves 115 the traffic policy 240 for that destination from a storage medium within system 200. At that point the system 200 makes a decision 120 whether an intercept is indicated. If an intercept is not indicated, the DNS server recursive resolves 125 the destination hostname to an IP address and the DNS server 220 constructs 130 the DNS response containing the resolved IP address and sends it to the mobile device 100 that issued the DNS query. If however an intercept query is indicated 120, the system 200 chooses 150 a substitute IP address and maps 155 the address to the original hostname. The substitute IP address and the original hostname data is saved 160 to a storage medium within system 200 where the DNS server 220 constructs 165 the DNS response containing the substitute IP address and sends to the mobile device 100.

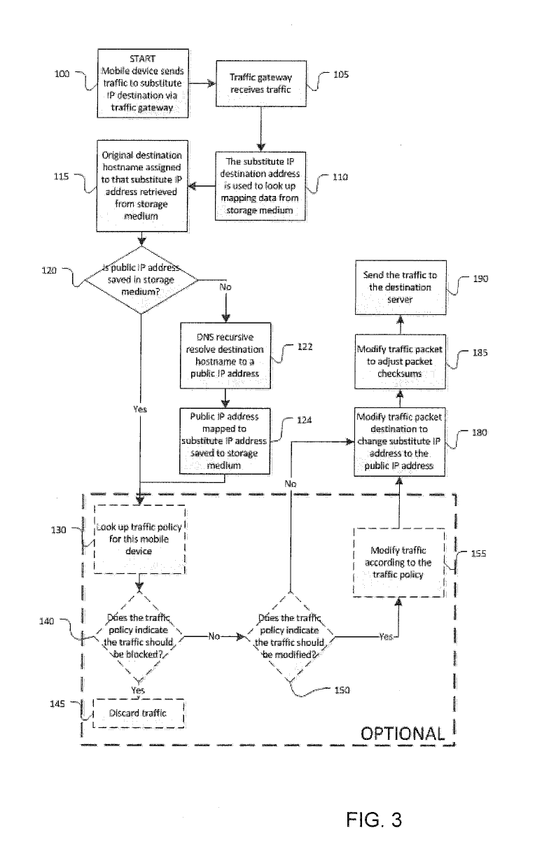

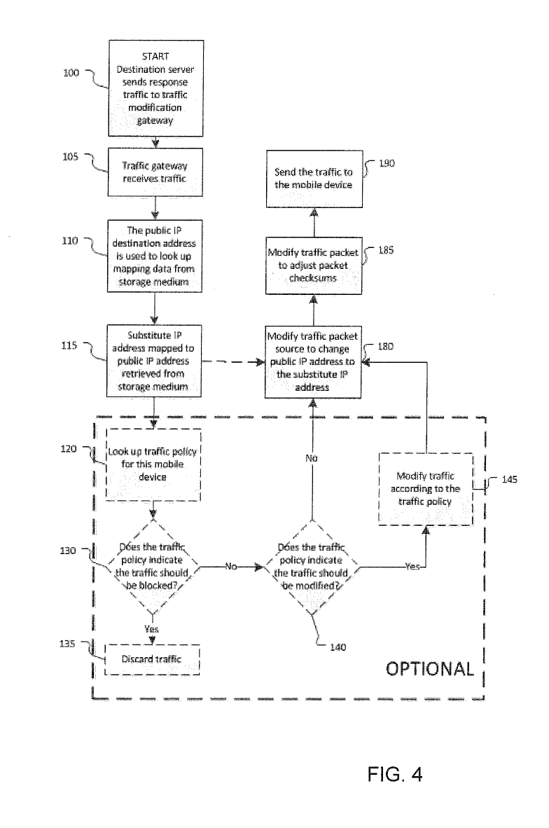

Referring now to FIG. 3, a logic flow chart of another aspect of the invention is shown, In FIG. 3, shows the flow of traffic coming from the mobile device and the Destination Network Address Translation (DNAT) being performed to modify the traffic from the substitute IP destination to the actual public IP destination. It will be understood by persons having ordinary skill in the art that the inspection/modification/blocking of the traffic, shown in FIG. 3, is optional. Referring specifically to FIG. 3, it will be seen that when the mobile device 100 sends traffic to a substitute IP destination via the traffic gateway 210 and the traffic is received 105 therein, a substitute IP destination address is used to look up 110 mapping data from a storage medium within system 200. The original destination hostname assigned to the substitute IP address is then retrieved 115 from storage medium in system 200. At this point the system 200 makes a decision 120 as to whether a public IP address is saved in the storage media and if not, the DNS recursive resolves 122 the destination host name to a public IP address, which is then mapped 124 to substitute the IP address that was saved to the storage medium. If the system determines that the public IP address is saved to the storage media the traffic packet destination is modified 180 to change the substitute IP address to the public IP address, packet checksums are adjusted 185 and the traffic is sent 190 to the destination server 300. Optionally, when system 200 makes a positive decision 120 that the public IP address is stored in system 200, it may then look up 130 the traffic policy 240 for the mobile device 100 and then determine whether the traffic policy 240 indicates whether the traffic should be blocked. If the traffic should be blocked, based on the traffic policy 240, the system can then discard the traffic, if the policy makes no indication, the system can then query 150 whether the traffic policy indicate that the traffic should be modified. If the policy indicates that no modification is necessary, the packet destination can be modified 180 to change the substitute IP address to the public IP address, packet checksums are adjusted 185 and the traffic is sent 190 to the destination server 300, as before. However, if the policy indicates modification is necessary, the traffic is modified 155 according to the policy and then the modification 180 of the destination can be made prior to sending 150 the traffic to the destination server 300. FIG. 4 will show the flow of the traffic from the destination server 300 to the mobile device 100.

FIG. 4 shows a flow chart showing the flow of traffic coming back from the destination server, and the Source Network Address Translation (SNAT) being performed to modify the traffic from the public IP to the substitute IP source address. It will be understood by persons having ordinary skill in the art that the inspection/modification/blocking of the traffic, shown in FIG. 4, is optional.

Referring now to FIG. 4, it will be seen that the traffic sent 190 to destination server 300 in FIG. 3, is responded to by the server 300 sending response traffic to the traffic modification gateway 210, where the traffic is received 105. The system 200 uses the public IP destination address to look up 110 mapping data from a storage medium within system 200 and substitute IP address is mapped 115 to the public IP address retrieved from storage. At this point the system 200 modifies 180 the traffic packet source to change the public IP address to the substitute IP address and the traffic packet is modified to adjust 185 the packet checksums. The traffic is then sent 190 to the mobile device 100. It will be seen that additionally an optional inspection, modification and/or blocking of the traffic can be completed prior to final modification and forwarding to the mobile device. As will be understood by persons having ordinary skill in the art, the traffic policy 240 can be looked up 120 by the system after retrieving 115 the public IP address is retrieved from the storage media within system 200. At that point, the system requests a look up 120 of the traffic policy for the mobile device 100 and a determination 130 is made as to whether or not the traffic should be blocked. If the policy indicates that the traffic should be blocked, the traffic can then be discarded. If the there is no policy or no negative indication for this traffic, a second inquiry can be made to determine if the traffic should be modified. If the policy indicates that the traffic should be modified, system 200 can modify 145 the traffic in accordance with the policy if not, the traffic can proceed to the mobile device 100 after the public IP address is substituted for the IP address and the packet check sums are adjusted 185.

Some embodiments of the present invention dynamically reduce the amount of traffic sent or received by a mobile device over a virtual private network. This is enabled in various embodiments by a VPN server dynamically directing the mobile device to communicate directly with non-VPN IP addresses when accessing specific types of traffic, when accessing specific types of web sites, or the like.

In some embodiments of the present invention, the mobile device initially communicates via a VPN traffic/security server to access the web. In various embodiments, depending upon the type of network traffic, the VPN server may direct the mobile device to access the web directly, i.e. not via the VPN server. As described in the embodiments below, this is implemented either by returning to the mobile device, the IP address of the VPN server as a resolution of a DNS query, or by returning to the mobile device, the actual IP address of the web site as a resolution of the DNS query. The mobile device will thus continue accessing data via the VPN server, or directly (i.e. not via the VPN server).

In some embodiments, the mobile device may be a portable phone, tablet computer, PDA, laptop, computer, or the like. For example, the mobile device may be an iOS-based device (e.g. Apple iPhone®, Apple iPad®); an Android-based device (e.g. Samsung Galaxy®, Asus Transformer®); a Windows-based device (e.g. Nokia Lumina®, Samsung Slate®); or the like.

In some embodiments, various web sites can be characterized based upon data types, such as high traffic type sites such as: video sharing sites (e.g. Youtube.com, Vimeo.com), audio streaming sties (e.g. Spotify.com, Pandora.com), video streaming sites (e.g. Netflix.com, Hulu.com). In addition, in some embodiments, web sites may be characterized as involving personal data, such as financial web sites (e.g. Fidelity.com, Schwab.com, WellsFargo.com); medical health data (e.g. Kaiserpermante.org,); or the like. In various embodiments, the VPN server may force the mobile device to access high traffic web sites, and web sites involving personal data directly, i.e. not via the VPN.

According to some embodiments of the present invention, the following steps may be performed:
1. A VPN connection is established between a mobile device and a traffic server.
2. A user using a mobile device attempts to connect to a particular web site on the Internet. In various embodiments, as an initial process, the mobile device requests resolution of a domain name portion of a web address/URL.
3. Next, the mobile device refers to the first DNS server named in a list of DNS servers to resolve the domain name. In various embodiments, the first DNS server refers to the VPN DNS server via the VPN connection.
4. Then, the mobile device sends the domain name to the VPN DNS server for DNS resolution.
5. In response, the VPN DNS server may pass the domain name to a DNS server on the private network or other DNS server, unless the resolved network address is already known.
6. The VPN DNS server receives the network address associated with the domain name from the DNS server.
7. In some embodiments, the traffic server also makes a determination as to what type of traffic is provided by the web site (e.g. high traffic data) or what type of web site data (e.g. personal, sensitive) is involved.
8. If the traffic type of the web site is of a type the traffic server does not want to carry on over the VPN, the resolved network address associated with the domain name is returned to the mobile device.
9. Subsequent to step 8, the mobile device then connects to the web site directly using the resolved network address. In such embodiments, the VPN is not burdened with such traffic For example, if the type of traffic is streaming video, e.g. Netflix, the VPN is not used.
10. If the traffic type of the web site is of a type the traffic server would like to monitor, the IP address of the VPN server (over VPN) is returned to the mobile device as the resolved network (IP) address.
11. Subsequent to step 10,
   a) the mobile device requests the web site data via the IP address of the VPN server;
   b) the VPN server requests the web site data using the resolved network address (IP) associated with the domain name, determined in step 6;
   c) the traffic server receives web site data using the resolved network address;
   d) the traffic server (optionally) modifies the web site data; and
   e) the web site data (or modified web site data) is returned to the mobile device.

In some embodiments, the web site data may be modified prior to sending the web site data to the mobile device. For example, certain options may become unavailable, and in other embodiments, certain options may be added. In some embodiments, the process of looking up the network address (e.g. resolving the network address) associated with the domain name may be refreshed periodically (e.g. 5 minutes), upon network connection or reconnection, or the like. Such embodiments allow the VPN to dynamically determine whether network traffic should be provided via the VPN or without the VPN. For example, in some cases, if the network load on the VPN server is heavy, the VPN server may direct a mobile device to access VoIP data directly from a VoIP server, and not via the VPN server. However, five minutes later, when the network load on the VPN server has lightened up, the VPN server may direct the mobile device to access VoIP data from the VoIP server via the VPN server.

In some embodiments, the VPN server may determine whether data is accessed via the VPN or not based upon network policies/configuration file. In one example, a configuration file may specify heavy traffic web sites should be accessed by the mobile device, not using the VPN. This configuration file may be easily updated. Accordingly, in some embodiments, upon every DNS name resolution request, the configuration file is retrieved a new and used as described above.

Further embodiments can be envisioned to one of ordinary skill in the art after reading this disclosure. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

In some embodiments of the present invention, the first DNS server on the list of DNS servers in step 3, above may not necessarily be referred-to by the mobile device. Accordingly, the following process may be performed so that the DNS server referred-to points to the VPN server: Upon initiation of the VPN, a list of IP addresses for mobile-carrier providers (e.g. ATT, Verizon, Sprint, etc) domain name servers (DNS) is determined; These DNS IP addresses are then remapped to the VPN server. Accordingly, when the mobile device attempts to resolve a domain name via a DNS of a mobile-carrier, the request in step 4, will be redirected to the corporate DNS server via the VPN server.

Although an illustrative embodiment of the invention has been shown and described, it is to be understood that various modifications and substitutions may be made by those skilled in the art without departing from the novel spirit and scope of the invention.

What is claimed is:

1. A method for dynamically directing mobile device traffic in a computing system comprising the steps of:
providing a computing system having elements for at least receiving and sending requests for resolution of a domain name associated with a web address from a mobile device and storing, reviewing and/or modifying requests for resolution of a domain name;
operating the computing system to receive a request for resolution of a domain name;
reviewing the received request for resolution of a domain name with the computing system;
determining whether the domain name is not subject to security policies;
determining a publically-accessible IP address associated with the domain name; and
when the domain name is determined to not be subject to the security policies, providing from the computing system, a publically-accessible IP address associated with the domain name to the mobile device.

2. The method of claim 1 wherein when the domain name is determined to be subject to the security policies, the method includes the step of providing from the computing system, an IP address associated with the computing system to the mobile device in response to the request for resolution of the domain name.

3. The method of claim 1 wherein the step of determining whether the domain name is not subject to security policies includes the further step of determining in the computing system whether the domain name is stored in a domain name list in storage.

4. The method of claim 3 including the step of placing domain names, including, but not limited to: Youtube.com, Vimeo.com, Spotify.com, Pandora.com, Netflix.com, Hulu.com, Fidelity.com, and Schwab.com in the domain name list in storage.

5. The method of claim 1 wherein the step of determining in the computing system whether the domain name is subject to security policies or not includes the steps of determining a traffic type associated with the domain name and determining whether the traffic type is subject to security policies.

6. The method of claim 5 including the step of providing the computing system with the traffic types that is not subject to the security policies.

7. The method of claim 1 further comprising the steps of:
receiving in the computing system, a request from a mobile device for web data associated with the web address via the IP address;
sending from the computing system, a request for web data associated with the web address to a web server associated with the publically-accessible IP address; and
receiving in the computing system, the web data associated with the web address from the web server associated with the publically-accessible IP address.

8. The method of claim 7 further comprising the steps of determining in the computing system, whether the web data should be modified and when it is determined that the web data should not be modified sending from the computing system, the web data associated with the web address to the mobile device in response to the request from the mobile device.

9. The method of claim 7 further comprising the steps of determining whether the web data should be modified and, when it is determined that the web data should be modified, sending the modified web data to the mobile device in response to the request from the mobile device.

10. The method of claim 1 wherein the IP address associated with the computing system comprises a virtual private network.
